(19) United States
(12) Patent Application Publication
(10) Pub. No.: US 2008/0174100 A1
(43) Pub. Date: Jul. 24, 2008

(54) Real time privilege management

(75) Inventor: Robert B. Reeves, Manchester, NH (US)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: AssureTec Systems, Inc.

(21) Appl. No.: 11/656,568

(22) Filed: Jan. 22, 2007

(51) Int. Cl. B42D 15/00

(52) U.S. Cl. 283/70

(57) ABSTRACT

A method is described for managing a generally automated, multilevel process for verifying both an already identified document type and the identity of a person presenting the document. A plurality of levels of document and identity verification checking steps are performed in real time. Each level of verification checking consists of additional, predetermined, ever more rigorous document and/or bearer identity verification checking steps performed in real time that vary depending on what type of document is involved, the authority that issued the document, why and where the document is being presented and other information about known problems with the types of documents. The document and/or bearer identity verification checking steps performed at each of the plurality of ever more rigorous verification checking steps vary dynamically depending on the outcome of the previous levels of verification checking, may be modified on the fly, and may be modified manually depending on the results of previous verification checking steps.

### PRIORITY APPLICATION

This application is a utility patent application claiming priority under a prior U.S. provisional application Ser. No. 60/556,933, filed 26 Mar. 2004, and entitled “Real Time Privilege Management”.

### FIELD OF THE INVENTION

This invention relates to a real time method for verifying identified types of documents or tokens presented for different privileges such traveling, entry into secure areas or performing certain transaction, and verifying the identity of the bearers of the documents based on predetermined verification protocols for checking each identified type of document to determine if the bearer is authorized to exercise the privilege.

### BACKGROUND OF THE INVENTION

In the prior art terminals have been used to read and verify different types of documents, including identity and/or travel documents. Over the years alteration and counterfeiting of such documents has been increasing and, to counter same, features have been incorporated into the documents to make it very difficult if not impossible to alter or counterfeit documents. In addition, biometric information is now being stored on identity and travel documents and is being compared to biometrics of bearers of documents. Further, documents and information thereon are being checked against information in databases to validate documents and verify their bearers.

To hinder such counterfeiting and alterations to identity, travel and similar documents, and documents having value, many innovations have been proposed and introduced. One solution has been the development and implementation of new materials for producing such documents that has made counterfeiting and alterations more difficult, and the detection of counterfeit and altered documents easier and faster. Such new materials include the use of holograms and retro-reflective layers in laminating material, invisible information that only appears when illuminated by certain wavelengths of invisible light or other energy, and different types of inks that are seen as one color under normal ambient light but are seen as a different color when illuminated by certain wavelengths of invisible light or other energy (chemical taggants). In addition, magnetic and radio frequency (RF) taggants that are invisible to the eye are added to base materials and laminating materials but may be detected using special equipment. Further, micro-miniature smart chips and memory chips are embedded in such documents, just as they are in smart cards, and may be used to identify, read and validate documents in which they are embedded, and to identify and validate the bearer of such documents. Biometric and other information about a person to whom a document is issued is stored in the memory chips and is used to validate a document and verify the person to whom it is issued.

An identity card using smart-card technology has been introduced in Malaysia where an embedded computer chip and memory allows the card to be used as a combination identity card, driver's license, cash card, national health service card, and passport.

Coupled with the increase of new materials and new techniques to produce documents that are more difficult to counterfeit or alter, there has been an increase in the demand for new equipment, systems and methods for testing and validating documents made from the new materials, for verifying the identity of a bearer of a document, for verifying that the bearer has authorization to participate in an activity represented by the document, and to determine if there are any known concerns about a document or its bearer. This demand has risen because it has become virtually impossible for a person, by them self, to analyze and validate documents made using such new materials and techniques, and to verify the identity of a document bearer.

However, criminals and terrorists too often have been issued valid identity and/or travel documents prior to becoming a criminal or being identified as a terrorist, or such documents are being wrongfully issued in false names to criminals and terrorists by corrupt officials in some countries. When investigating the terrorists who performed the terrorist acts of Sep. 11, 2001 it was found that some of them had multiple, false, but otherwise valid passports in different names and from different countries. Validation and verification terminals designed to detect altered and counterfeit identity and/or travel documents will not detect such “valid” documents wrongfully issued to and used by criminals and terrorists.

In addition, some individuals steal the identity of other individuals by first obtaining duplicate birth certificates and other documents, which is too easily done, and these documents are then used to fraudulently obtain other “valid” documents, such as passports and identity cards including national identity cards. Validation and verification terminals designed to detect altered and counterfeit identity and/or travel documents will not detect such “valid” documents wrongfully issued to and used by criminals and terrorists.

Thus, there is a need in the art for better apparatus and methods for document validation and identity verification that can help identify terrorists, criminals and other individuals who wrongfully attempt to obtain official documents, to detect wrongfully obtained but otherwise valid documents, and to detect altered or counterfeit documents used to obtain other valid documents such as passports, birth certificates and drivers licenses, while at the same time simplifying the process.

### SUMMARY OF THE INVENTION

The above described need in the prior art is satisfied by the present invention which functions with document validation and bearer identity verification apparatus such as described in U.S. patent application Ser. No. 09/994,399 filed Nov. 26, 2001 and entitled “Validation and Verification Apparatus and Method”; and U.S. patent application Ser. No. 10/022,634 filed Dec. 17, 2001 and entitled “Document and Bearer Verification System”.

In accordance with the teaching of the present invention a plurality of levels of document and identity verification checking steps are performed in real time that go beyond checking a document to determine if it is valid, counterfeit, or has been altered, and verifying that a person presenting a document is the person whose biometric information is encoded on the document. Each level consists of additional, predetermined, ever more rigorous document validity and/or bearer identity verification checking steps performed in real time and that vary depending on what type of document is involved, the authority that issued the document, why and where the document is being presented and other information about known problems with the types of documents. The additional checking steps performed for an identity document presented for air travel are more rigorous than the checking steps performed when the same document is presented to travel on a bus, and even fewer checking steps are performed if the same document is presented to purchase alcoholic beverages in a liquor store. Thus, a list of the additional, predetermined, more rigorous document validity and/or bearer identity verification checking steps to be performed is different for each type of privileged function to be engaged in. In addition, the exact document validity and/or bearer identity verification checking steps performed at each of the plurality of rigorous checking steps will vary dynamically depending on the outcome of the previous levels of checking, may be modified on the fly, and may be modified manually depending on the results of previous checking steps. While the terms document and passport are used herein it must be understood that while many things that may conventionally be considered to be documents are included, many other things may be encompassed by the teaching of the invention such as smart cards, electronic keys, etc.

Information, including biometric information, stored on a presented document may be used to access many databases and compared against information stored in the data bases to determine if a document has been validly issued and has been validly issued to the right person, in order to validate documents and verify the identity of their bearers.

For example, biometric information such as a fingerprint may be obtained directly from the bearer/presenter and/or from a document and be forwarded to a database such as the FBI fingerprint database, or equivalent databases in other countries including the Interpol database, for automatic comparison in real time to identity of a person presenting a document or the person to whom a document is being issued. This level of checking may also be done with iris prints.

In addition, the information on a document, including the biometric information, and information retrieved from databases is used to determine in real time if a persons bearing and presenting a document is wanted, is on a watch list, is authorized to access some location, or is authorized to take part in some activity such as travel.

Similarly, the information and biometrics submitted by a person seeking to obtain issuance of a valid document can be quickly and extensively checked in real time using secure databases of many governmental and other authorities at all levels, in the U.S. and other countries, to determine if the applicant person is who they claim they are, and they are not restricted from obtaining and using a requested document.

The databases checked in the U.S. include the many federal, state, municipal and private databases. A person will normally have historical records in these many databases showing their existence over the years of their life. If there are no such records in existence on the databases the person is obviously suspect and further checking is necessary. In addition, the information from the many databases can be compared with information obtained directly from a person to resolve incongruities. In this manner it makes it very difficult, if not impossible, for someone to wrongfully obtain, or to use a wrongfully obtained, altered or counterfeit document.

At the same time, before document issuance is authorized, the submitted information and biometrics can be used to determine in real time if the applicant is wanted, is on watch lists, is authorized to access some location, or is authorized to take part in some activity such as travel, entering a secure area or purchasing restricted goods. Thus, it is much harder to wrongfully obtain valid documents and to use them.

In accordance with the teaching of the invention more rigorous document validation and bearer identity verification varies, depending on the type and source of a document, and what the document is used for, according to pre-determined criteria that may be quickly changed as necessary. This provides increased security while speeding up the process of validating and checking documents and the persons to whom they are issued.

Prior art initial document reading and validation checks are first performed on a submitted document to determine what type of document it is, what is on the document, and if the document is counterfeit or has been altered. Next biometric checks may also be performed to match biometric information encoded and stored on the document with biometrics of the person presenting the document. Then a check may also be performed to determine if a person carrying and submitting a document is wanted and should be detained, or is on a watch list.

In accordance with the teaching of the present invention more rigorous checking of document validity and identity verification of the persons presenting the documents is then performed. For example, if a document being checked and validated is determined to be a passport from a specific country the first step is to determine what type of additional validation checking should be performed for passports from the specific country. It is known that a specific group of countries very carefully perform identity and background checks before issuing passports or other documents, and there is no problem with corrupt officials wrongfully issuing otherwise valid passports or other documents. In addition, it may be known that, due to the stringent identity and background checks performed that very few if any passport or other document holder/bearers from these specific countries have any links with terrorist or other criminal organizations. Accordingly, it is not necessary to perform overly stringent validation checks on documents and identity checks on the persons carrying and submitting such documents from the specific countries. The pre-determined document validation and bearer identity verification checking steps are thus reduced and the checking and verification process is speeded up. This is particularly important at busy ports of entry to countries such as major international airports.

On the other hand there are other countries that do not carefully perform identity and background checks before issuing passports and other documents, and/or there is a problem with corrupt officials wrongfully issuing otherwise valid passports and other documents. Accordingly, otherwise valid passports and other documents are issued by these countries to criminals, terrorists and others who are not to be allowed entry into a country. Thus, it is necessary to perform additional, more stringent validation checks using various databases to determine if a passport or other document has been validly issued, has been validly issued to the right person, and to determine if a person bearing and presenting a passport or other document is wanted, is on a watch list, is authorized to access some location, or is authorized to take part in some activity such as travel. Finally, a record of use of the passports or other document can be made.

Thus, upon a determination that a submitted passport is a U.S. passport for which rigorous checking is done during the issuance of the passport, fewer document validation checks are performed than if the submitted passport is from a terrorist supporting country which has been known to issue their passports to terrorists.

Criteria other than listed above may also be specified regarding documents or their bearers that will cause closer inspection of documents or their bearers. For example, if an unidentified murderer is known to be in a given age range, sex, height and weight, all persons submitting documents with such biometric characteristics thereon may be flagged for closer scrutiny to determine if they are the wanted individual.

### DESCRIPTION OF THE DRAWING

The invention will be better understood upon reading the following Detail Description in conjunction with the drawing in which:

FIG. 1 is a general block diagram of a plurality of document verification and document creation terminals working in conjunction with a network of trust authorities to verify information submitted when applying for documents;

FIG. 2 is a more detailed block diagram of an information and document verification system utilizing trust authorities to access federal, state, private and foreign databases in a secure, private manner to verify information submitted when applying for original replacement documents; and to check documents and the individuals to whom they are issued when they are presented for use;

FIG. 3 is a block diagram of the steps performed in initial document validation and identity verification; and

FIG. 4 is a block diagram of the operations performed by a trust authority server in functioning with a verification system server to verify information submitted when applying for documents; and to checking document and the individuals presenting them; and

FIG. 5 is a block diagram of the steps performed in multi-level, rigorous checking of documents, the individuals to whom they are issued, and presenters of documents in accordance with the teaching of the present invention.

### DETAILED DESCRIPTION

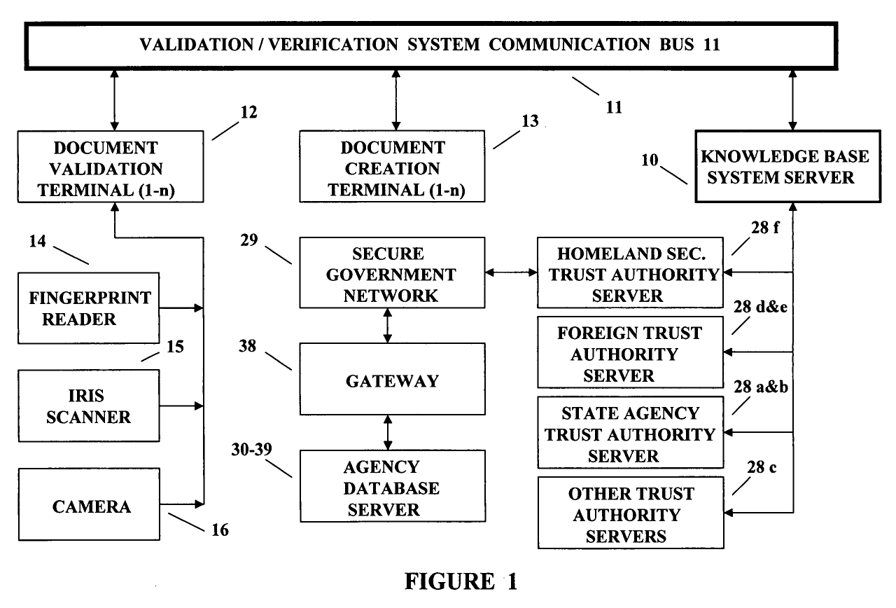

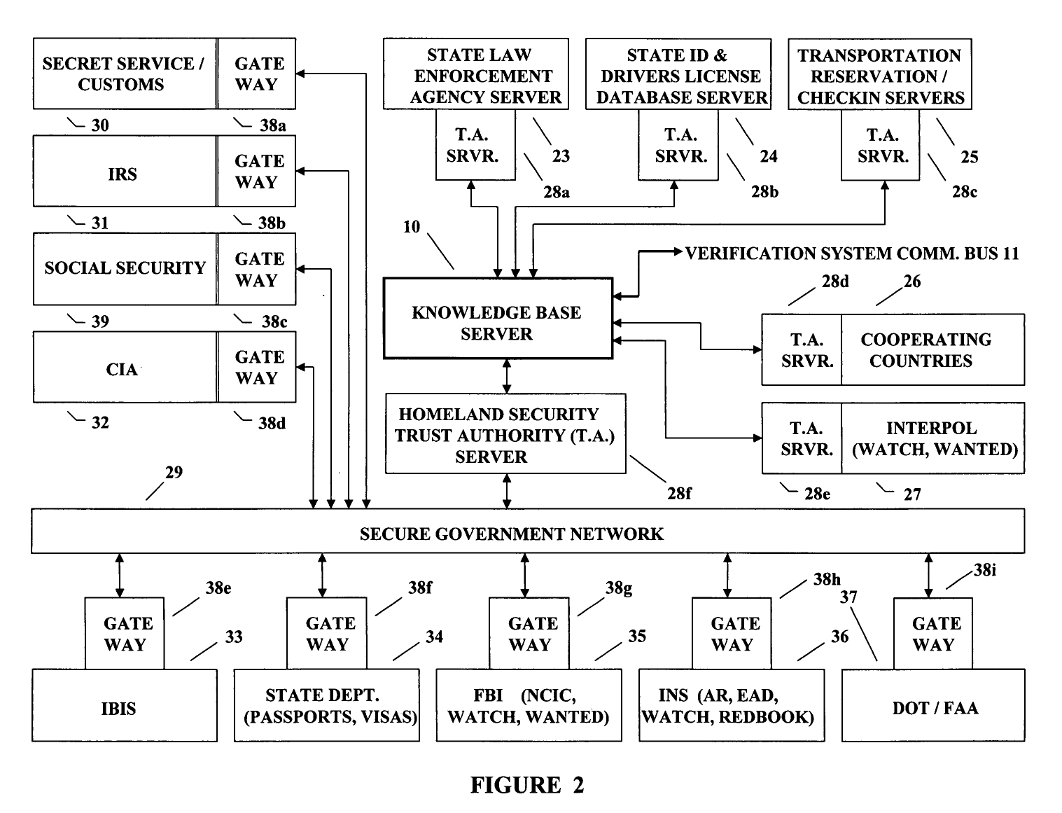

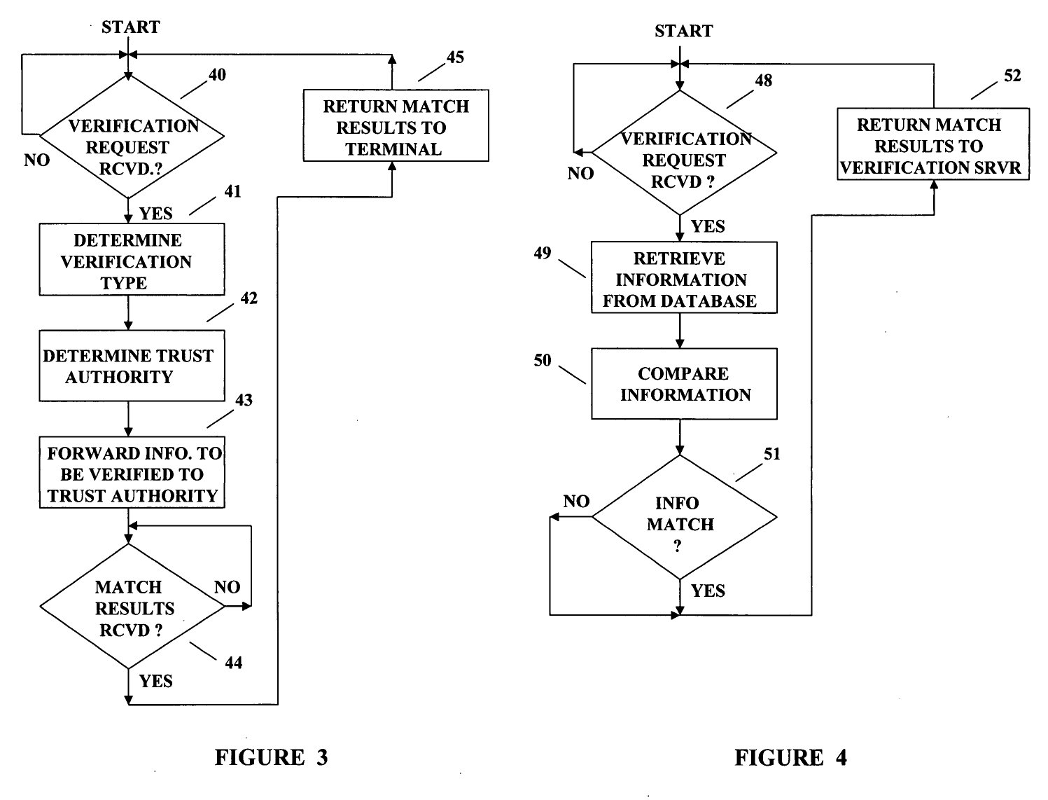

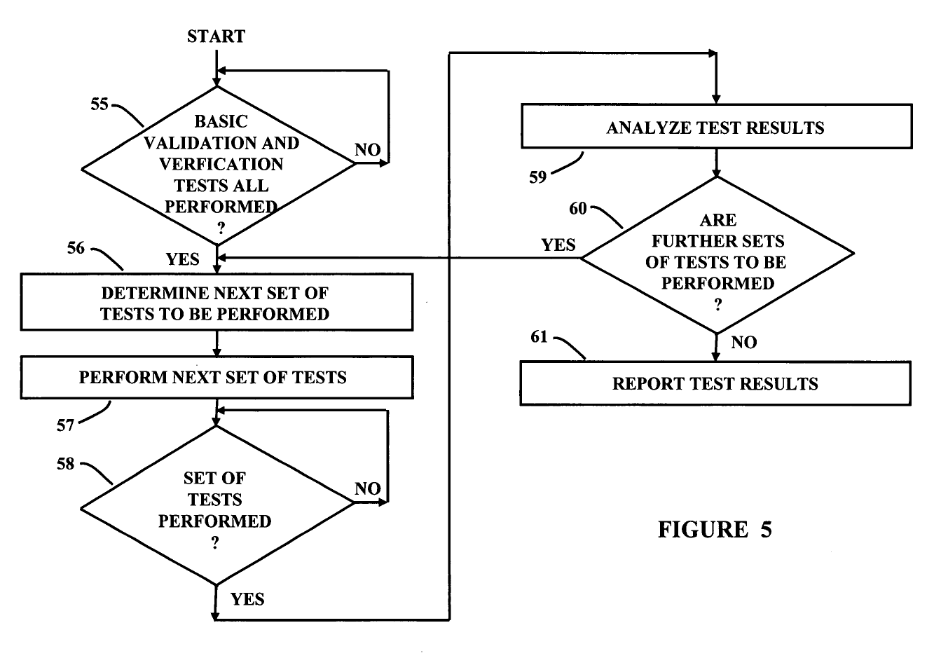

In the following description FIGS. 1 and 2 show a system with which the real time process of the present invention shown and described with reference to FIG. 5 is implemented. The steps of the system described in conjunction with FIGS. 1 and 2 are more specifically described in detail with reference to FIGS. 3-4. In addition, the words passport and document are used interchangeably in this description. While passports are specifically mentioned herein, documents may include other things such as, but not limited to, identity cards, drivers licenses, purchase approvals, bonds and entry passes. In addition, many other things, such as smart cards, identity chips and electronic keys are contemplated to be covered by the subject invention and are called documents herein for the sake of simplicity. The words testing and checking are used interchangeably and carry the same meaning throughout this Detailed Description.

The terminal apparatus 12 shown in FIG. 1 is typically used to read documents, to basically validate documents to determine that they are not altered or counterfeit, and to basically verify the identity of persons bearing and submitting documents for such things as travel, entry into countries, entry into secure facilities, opening bank accounts, and purchasing restricted materials.

Such first level document validation and bearer identity verification helps identify terrorists, criminals and other individuals who hold altered or counterfeit passports or other official documents, detect wrongfully obtained but otherwise valid documents such as drivers licenses, birth certificates and passports, and to prevent obtaining same initially; and to prevent wrongfully obtaining official documents such as passports using altered or counterfeit documents or other documents wrongfully obtained. Apparatus and methods for doing this are known in the art.

Using the multi-level, more rigorous document and identity checking of the present invention the validity of submitted documents and the identity of persons submitting such documents may be verified in manner heretofore not done in the prior art.

Criminals and terrorists too often have been issued valid identity and/or travel documents prior to becoming a criminal or being identified as a terrorist, or such documents are being wrongfully issued in false names to criminals and terrorists by corrupt officials in some countries. When investigating the terrorists who performed the terrorist acts of Sep. 11, 2001 it was found that some of them had multiple, false, but otherwise valid passports in different names and from different countries. Validation and verification terminals designed to detect altered and counterfeit identity and/or travel documents will not detect such “valid” documents wrongfully issued to and used by criminals and terrorists.

In addition, some individuals steal the identity of other individuals by first obtaining duplicate birth certificates and other documents, which has been too easily done, and these documents are then used to fraudulently obtain other “valid” documents, such as passports and identity cards including national identity cards. Validation and verification terminals designed to detect altered and counterfeit identity and/or travel documents will not detect such “valid” documents wrongfully issued to and used by criminals and terrorists.

Terminal apparatus 13 is used when the issuance of new documents is being requested. It is used to verify the identity of a person requesting a new document and to validate supporting documents submitted to determine that they are not altered or counterfeit.

For example, when a document, such a birth certificate, is being submitted to obtain another document, such as a passport, document validation and identity verification are performed, as necessary, to verify that the submitted document(s), birth certificate in this example, are valid, have been rightfully issued to an individual, and that they have not been altered and are not counterfeit.

In addition, using the more rigorous document validity and identity verification checking of the present invention, the identity of a person requesting the issuance of a new document; or using a document to travel, enter into secure facilities, opening bank accounts, and purchasing restricted materials; is the person they claim to be and are rightfully entitled to be issued the document or to travel etcetera per a privilege connoted by the document. This is accomplished in real time using knowledge databases comprising the many existing databases maintained by federal, state, municipal and private agencies and organizations to verify that the person requesting the document is the person they claim to be and are rightfully entitled to a document and to use the document for its intended purpose. This greatly minimizes anyone wrongfully obtaining otherwise valid documents.

A document may be presented to access more than one privilege. For example a passport may be used to travel by aircraft and may be used to purchase alcoholic beverages. In accordance with the teaching of the present invention the additional checking steps performed for an identity document such as a passport presented for air travel to another country are more rigorous than the checking steps performed when the passport is presented to travel on a bus, and even fewer checking steps are performed if the same document is presented to purchase alcoholic beverages in a liquor store. In summary, the checking protocol for each type of document varies depending where and why the document is presented and for what privilege.

Thus, a list of the additional, predetermined, more rigorous document validity and /or bearer identity verification checking steps to be performed is different for each type of privileged function to be engaged in. The different lists are utilized by different document validity and identity verification equipment at locations where different privileged functions are to be engaged in.

Before describing the real time method of more rigorous testing of document validation and identity verification provided by the present invention the validation and verification system in which the invention operates must first described. This system is shown and described with reference to FIGS. 1-4.

Wrongfully obtaining some documents is too easy and common due to the ease in fraudulently obtaining a driver's license, state identity card, birth certificate, and a Social Security number and then using those documents as proof of identity to obtain other, higher quality documents such as a passport or national ID card.

An application for a minor to receive a Social Security number requires only the testimony of a parent or a birth certificate that may be counterfeit or has been wrongfully obtained. A driver's license, state identification card, passport or work permit are all linked to the birth certificate and/or the Social Security number. Therefore, no positive biometric link exists to the person who obtains the documents.

The certification/notification of deaths is presently even more poorly controlled. There is no flag placed on a birth record and, unless a deceased person has been collecting a Social Security benefit and Social Security was notified of the death, there is no retirement of the person's Social Security number or prevention of someone from assuming the identity of the deceased.

Even the new alien residence card has little true security since there is no rigorous process of identity verification to assure that the card was legitimately issued to a person or that the person is who they say they are. In addition, there is no accountability placed upon employers to authenticate the document or to verify that the bearer is the person to whom the document was issued.

A more practical way to achieve increased security involves the use of currently existing global identification documents and the many databases that service them, where access to and data from the databases are controlled by trust authorities, and privacy concerns are adequately addressed by greatly limiting dissemination of information from these databases. For one example, a trust authority server for a database(s) will compare a birth date retrieved from a submitted document against the birth date stored in the server's associated database and return a response of “match” or “no match” to the remote verification terminal that initiated the inquiry for a birth date match. This comparison checking may be repeated for the many other existing databases and possibly new databases.

Standardized communication protocols provide real-time yes/no/maybe type document inquiry results on-line from appropriate database trust authorities. Watch list and privacy-protecting smart pattern recognition technologies provide cross database exception reporting to further improve security, and as the public issues surrounding biometric identification methodologies are resolved, positive identity verification would become even more comprehensive.

In accordance with the teaching of the present invention a plurality of levels of checking steps may be performed in real time that go beyond checking a document to determine if it is valid, counterfeit, or has been altered, and verifying that a person presenting a document is the person whose biometric information is encoded on the document. Each step consists of one or more predetermined document validity and/or bearer identity verification checking steps that vary depending on what type of document is involved, the authority that issued the document, and other information about known problems with the types of document. In addition, the exact document validity and/or bearer identity verification checking steps performed in real time at each of the plurality of checking steps will vary dynamically depending on the outcome of previous levels of checking.

For example, if a document being checked and validated is determined to be a passport from a specific country the first step is to determine what type of additional validation checking should be performed for passports from the specific country. It is known that a specific group of countries, including the United States, very carefully perform identity and background checks before issuing passports or other official documents, and there is no problem with corrupt officials wrongfully issuing otherwise valid passports or other documents. In addition, is known that, due to the stringent identity and background checks performed that very few if any passport or other document holder/bearers from these specific countries have any links with terrorist or other criminal organizations. Accordingly, it is not necessary to perform additional rigorous validation checks on documents and identity checks on the persons carrying and submitting such documents from these countries. Any additional steps beyond checking that a document is not altered or counterfeit, and the biometrics on the document match the biometrics of the document bearer/presenter may only consist of checking if the name of the document bearer is wanted or is on a watch list.

The predetermined, additional document checking and bearer identification verification steps are thus reduced for documents from some countries. This is particularly important at busy ports of entry to countries such as major international airports.

On the other hand there are other countries that do not carefully perform identity and background checks before issuing their passports and other documents. When a passport from such a country is detected the additional, predetermined document validity and/or bearer identity verification checking steps to be performed are increased. The additional checking steps to be performed are retrieved from a memory and are performed. The additional steps most likely will include checking if the name of the document bearer is wanted or is on a watch list. It may also include a check to see if the number of a submitted passport is in a list of stolen passports. It may also include performing some biometric information comparisons such as comparing embedded fingerprints against fingerprints stored in the databases of the FBI, Interpol and other countries such as England, France and Germany.

There are also countries that support state terrorism where corrupt officials wrongfully issue seemingly valid passports and other documents. Accordingly, otherwise valid passports and other documents are issued by these countries to criminals, terrorists and others who are not ordinarily permitted entry into a country. Thus, it is necessary to perform additional, more stringent validation checks using various databases to determine if a passport or other document has been validly issued to a person who is not a criminal or a terrorist. For such countries the number of predetermined document validity and/or bearer identity verification checking steps to be performed are increased even further. They will include the checks described in the previous paragraphs plus many other document and identity checks.

For example, biometric information such as a fingerprint may be obtained directly from the bearer/presenter and be forwarded to a database such as the FBI fingerprint database, or equivalent databases in other countries including the Interpol database, for automatic comparison and possible identity of the person presenting the document or the person to whom the document was issued. This level of checking may also be done using iris prints.

Finally, a record of use of a passport or other document is made.

Additional checking criteria other than those listed above may be specified regarding documents or their bearers that will cause closer inspection of documents and their bearers. For example, if an unidentified murderer is known to be in a given age range, sex, height, race, color eyes and weight, all persons submitting documents with such biometric characteristics thereon may be flagged for closer scrutiny to determine if they are the wanted individual.

Similarly, information, supporting documents and biometrics submitted by a person seeking to obtain issuance of another valid document can be quickly and extensively checked in real time using secure databases of many governmental and other authorities at all levels, in the U.S. and other countries, to determine if the applicant is who they claim they are, and they are not restricted from obtaining and/or using a requested document.

The databases checked in the U.S. include the many federal, state, municipal and private databases. A person will normally have historical records in these many databases showing their existence over the years of their life. If there are no such records in existence on the databases that match information on documents submitted by a person, that person is obviously suspect and further checking is necessary. In addition, the information from the many databases can be compared with information obtained directly from a person to resolve incongruities. In this manner it is very difficult for someone to wrongfully obtain, or to use a wrongfully obtained, but otherwise valid document.

At the same time, before document issuance is authorized, submitted documents, information and biometrics can be used to determine if the applicant is wanted, is on watch lists, is authorized to access some location, or is authorized to take part in some activity such as travel. Thus, it is much harder to wrongfully obtain valid documents and to use them.

In accordance with the teaching of the invention document validation checking and bearer verification testing varies, depending on the type and source of a document, according to pre-determined criteria. This provides increased security while speeding up the process of validating and checking documents and the persons to whom they are issued.

Before the invention is described in detail with reference to FIG. 5, the system in which the present invention works is described with reference to FIGS. 1 through 4. This is done so the method of the invention will be better understood.

FIG. 1 shows a general block diagram of a plurality of document creation terminals 13 (1-n) and a plurality of validation terminals 12 (1-n) connected together in a document validation and identity verification system. The system includes a network of trust authorities servers 28 (a-f) accessing other networks such as 29, gateways such as 38, and database servers such as 30-39, and all are accessed via a verification system server 10 to verify the identity of individuals by verifying personal information they submit when applying for issuance of new documents, and to later validate issued documents and verify the identity of the individuals to whom they are issued. The document creation terminals 13 and validation terminals 12 are all connected via a validation/verification system communication bus 11 to knowledge base system server 10.

Documents such as passports are presented at validation terminals 12 when their bearer is traveling or wishes to travel. During a first level of checking the documents are analyzed to determine if they are valid, counterfeit or altered. Then, a check is made to determine if there are any concerns about the document or the document bearer, such as they being on a “watch list”, being banned from traveling or from taking place in some activity, or being wanted by the authorities in any country. Finally, a record of use of the document can be made. The document validation testing is done right at a validation terminal

Depending upon the intended use of a document validation terminal 12 or a document creation terminal 13, some terminals, such as ones of the plurality of terminals (1-n) 12, or ones of the plurality of terminals (1-n) 13, have additional equipment associated therewith. Examples are a fingerprint reader 14, and iris scanner 15, and a camera 16.

An image of a document applicant or document presenter may be captured by a camera 16 to be forwarded via verification system communication bus 11 to verification system server 10 which decides which of trust authorities 23 through 27 the image should be forwarded to be automatically compared to an image stored in the trust authority database. Using facial match technology that is well known in the art, the presenter image captured using camera 16 is compared to a presenter image stored in and retrieved from the database of the selected trust authority. The comparison is made by the trust authority and an indication of the quality of the match is returned to verification system server 10 to be returned via bus 11 to a document verifier terminal 12 or to a document creation terminal 13. In this manner the privacy of the document applicant and document presenter is preserved as previously described.

Alternatively, if a facial match cannot be positively made or refuted with any degree of certainty, the image retrieved from the database with the selected trust authority may be returned to a document verifier terminal 12 or document creation terminal 13 where an operator manually performs the facial match function. This may be necessary in instances when a document presenter has a beard or is wearing glasses and their image is changed to the point that an automatic facial match may not be made. The image of the document applicant or document presenter retrieved from the database is forwarded to the terminal 12 or 13 so that the operator thereof can manually compare the retrieved image to the document applicant or document presenter. However, normally in this case, a “live” photo is taken of the applicant or presenter and this is returned to the trust authority for manual matching by a resident identification expert.

A fingerprint reader 14 is used to capture fingerprints of a document applicant or document presenter to be compared to fingerprints stored on the document during a first step of document validation and identity verification in accordance with the teaching of the subject invention. Depending on the outcome of the first step of testing a second step of document validation and identity verification is performed in accordance with the teaching of the subject invention as is described in detail further in this Detailed Description. If further verification of the identity of the document applicant or presenter is required the fingerprints may be forwarded via verification system communication bus 11 and verification system server 10 to a trust authority to be processed in the same way as described in the previous paragraph. The fingerprint database most likely to be utilized is the FBI database and the fingerprints captured by a reader 14 are forwarded by bus 11, and server 10 to trust authority server 22. Server 22 determines that the FBI database is to be accessed for the verification and forwards a request over secure government network 29 through gateway 38g to the FBI server 35 where the fingerprints for the identified document applicant or presenter are retrieved and returned to trust authority server 22 where they are compared to the fingerprints forwarded from document verifier terminal 12 or document creation terminal 13 and a “match” or “no match” indication is returned to server 10 and on to terminal 12 or 13. In instances where a terminal 12 has no fingerprint reader 14, but fingerprints are retrieved from a presented document, the fingerprints may be manually verified.

Iris scanner 15 is used to capture an iris scan of a document presenter to be compared to an iris scan stored on the document. For verification of the identity of a document applicant or a document presenter the iris scan obtained may be forwarded via bus 11 to verification system server 10 to be processed in the same way as described in the previous two paragraphs for facial images and fingerprints to be compared against a stored and retrieved iris scan in a database, where the comparison is performed at either the trust authority server or the verification system server 10. In instances where a terminal, such as a terminal 12, has no iris scanner 15, but an iris scan is retrieved from a presented document, the iris scan may be manually verified.

In some applications there may not be a requirement to perform the verification of biometric information retrieved directly from a document presenter as described in the previous paragraphs. A basic document validation terminal 12 may then be utilized that has no fingerprint reader 14, iris scanner 15 and camera 16. Biometric information stored on a presented document may still be verified against biometric information stored in databases as described above.

Other than information and biometric verification as described in the previous paragraphs, databases associate with trust authorities will still be accessed at the different steps of document validation and identity verification, in accordance with teaching of the present invention, to determine a number of things including if a document applicant or a document presenter is wanted for a crime, and/or is on a watch list including a denied entry list, and/or to determine if there are known concerns about the document applicant, document or document presenter. In such cases, information submitted by the document applicant, or retrieved from the document being verified by document verifier terminal 12 is forwarded via verification system server 10 to an appropriate trust authority server for processing and an indication is returned via server 10 to terminal 12 or 13 indicating if the document applicant or document presenter is wanted for a crime, and/or is on a watch list including a denied entry list, and/or indicating any other known concerns about the document applicant, the document or its presenter.

As may be seen in FIG. 1 there is a homeland security trust authority server 28f that functions to verify information submitted by applicants for issuance of a new document, retrieved from issued documents, or obtained directly from a document presenter with information stored in databases on a secure government network 29, whether that network is a state or federal network. As seen in FIG. 2 the servers 30-39 for different government agencies are each connected via a gateway 38a-i to the secure government network 29 and are presently used for inter-agency access to data stored in databases on the servers connected to network 29. Trust authority server 22 provides secure, privacy controlled access to information in the databases on servers 30-39 to verify issued documents or their presenters, to verify the identity of document applicants, and to determine if there are any other known concerns about a document applicant, issued document or its presenter. In this way of privacy concerns are adequately met.

To increase the effectiveness of the system the databases of foreign governments may be accessed via secure communications links and foreign trust authority servers 26, 27 to obtain secure, privacy controlled access to information and/or verification of authenticity of a document or its presenter, and to determine if there are any known concerns by the foreign government about the document or its presenter.

Similarly, the databases of the fifty states may be accessed during the different steps of document validation and identity verification via secure communications links and state agency trust authority servers 23,24 to obtain secure, privacy controlled access to information, to verify the identity of a document applicant, verify the authenticity of an issued document or its presenter, and to determine if there are any other known concerns by a state agency about a document applicant, an issued document or its presenter. This might be necessary if the identity of a document applicant or document presenter is in doubt and they are asked questions, the answers to which are compared to information from a state database in an attempt to verify if the document applicant or document presenter is the person they claim to be. While direct access to state agency trust authority servers is shown, state agency servers having database may be connected to a secure government network that is accessed via a single trust authority server, such as the U.S. government secure network accessed using trust authority server 22.

Also, private databases of organizations or businesses such as, but not limited to, health providers, banks, credit card companies, airlines, railroads, schools and employers may be accessed via secure communications links and a trust authority server 25 to obtain secure, privacy controlled access to information of a document applicant or document presenter that may be needed to verify their identity. This might be necessary if the identity of a document applicant or document presenter is in doubt and they are asked personal questions the answers to which are compared to information from a private database in an attempt to verify if the document applicant or document presenter are the person they claim to be.

Techniques are known in the art for testing a document to determine if it is valid, counterfeit or altered. See the two patent applications identified in the first paragraph of the Summary of the Invention. Information is generated by governmental authorities concerning if there are any concerns about specified documents and/or the document bearers, such as they being on a “watch list”, being banned from traveling or from taking place in some activity, or being wanted by the authorities in any country. Such information may be downloaded to all terminals 12 and 13 on a daily basis, or more often, for this part of first level of testing of the prior art. Alternatively, the information may be stored in a database of a server 28 or 30 through 39 and accessed via validation/verification system verification bus 11 and knowledge base system server 10.

After testing the validity of a document, if is determined that the document has been altered or is counterfeit, or if document bearer is on a wanted list, the bearer/presenter of the document is immediately detained and/or arrested. If the document bearer is restricted from traveling or entering someplace, or performing some activity, they are turned away and a record is made of the attempt to travel or enter.

As described above a record of use of the document can be made. Such a record could be the details regarding a bearer/presenter of a document entering a country or traveling to another country, entering a secure facility, etc. This record may be stored in the plurality of terminals 12 and uploaded periodically to one or more specific central databases associated with a central server 28 or 30 through 39.

In FIG. 2 is a more detailed block diagram of a document validation and identity verification system utilizing trust authorities to access federal, state, private and foreign databases via trust authority servers in a secure manner to verify the validity of issued documents and the identity of individuals to whom the documents are issued, while addressing privacy concerns. In the middle of FIG. 2 is Knowledge base server 10 and verification system communication bus 11 described in the previous paragraphs with reference to FIG. 1. As previously described, server 10 determines which trust authority servers are to be accessed in a secure manner, and at which times, as part of the operation of a document verifier terminal 12 or a document creation terminal 13 in verifying source information from document applicants, issued documents and document presenters during the validation and verification steps of the present invention. Those steps are described in greater detail with reference to FIGS. 3 and 4. In addition, in some cases, an individual database, such as on transportation reservation/check-in system server 25, may not have its own trust authority server and verification system server 10 may act as its trust authority, if a trust authority is required. All databases requiring a trust authority are accessed via their respective trust authority server 23-28, and they are all connected to server 10. All communication paths between these servers are preferably secure communication channels, not accessible from the outside, and over which all communications are encrypted. As previously mentioned information passes between server 10 and all trust authority servers 28, and decisions made at either server 10 or ones of servers 28, is done in a manner to protect privacy of a document applicant at a document creation terminal 13 or document presenter at a document verifier terminal 12.

The aforementioned government, state and private databases are presently created and maintained by the issuing authority for each document type and by other organizations that have the control authority or operational charter to do so as a part of their business model. New trust authorities authorized to access such databases, as described above, will be used to access the databases using standardized privacy protected ID data routing, and a query/response system focused on risk assessment. That is, the trust authority server 28 for federal government databases will compare information, such as a birth date retrieved by a document validation terminal 12 from a submitted document against the birth date stored in its associated database and return a response of “match” or “no match” to the remote terminal 12 that initiated the inquiry for a birth date verification. Similarly, a birth date submitted by an applicant at a document creation terminal 13 will similarly be checked against such databases.

For birth records the database(s) connected to state agency trust authority server 28 a&b will be accessed. The database(s) of each state will be accessed via server 28 a&b. For another example, a trust authority server 28 will compare other information, such as the submitted maiden name of a document applicant's mother, to such information stored in a state birth record database and return a response of “match” or “no match” via the intermediate servers to the remote document creation terminal 13 that initiated the inquiry. Alternatively, in cases where databases may be accessed, but there is no trust authority server associated therewith, verification system server 10 may act as the trust authority, perform verification checks and return the same information comparison results to requesting ones of terminals 12 and 13. In this manner privacy issues are adequately addressed since there is usually no access to database contents, and actual information in the database(s) is not disclosed at any terminal 12 or 13. In some circumstances information retrieved from a database, such as a photo, will not be matched at the associated trust authority server but may instead a stored photo be returned to the terminal 12 or 13 from which the request was initiated, and an operator who made the request for the photo will perform a manual comparison of the photo retrieved from the database with the document presenter.

Shown connected to verification system server 10 in FIG. 2 are four examples of types of trust authority servers. There are state agency databases such as, but not limited to, state law enforcement agency database servers 23 accessed via trust authority server 28a, and state driver's license and identification card database servers 24 accessed via trust authority server 28b. There are also private databases such as transportation reservation/check-in database servers 25 that are accessed by trust authority server 28c. Examples of other types of private database servers, not shown, that might be connected to verification system server 10 are credit card database servers and medical record database servers.

As shown in FIG. 2, each of the database servers 23-27 & 30-39 are accessed via a trust authority server 28a-28f but, as previously described, all database servers within a particular group of servers, such as for a particular state, may be connected to a common secured state network and a single trust authority server is utilized to access the secured state network to access the state database servers to verify source information from a document verifier terminal 12.

The U.S. government interconnects its database servers using one or more networks, such as secure government network 29. As shown in FIG. 2 there are nine database servers 38e-38i connected to secure government network 29 via gateways 33-37. The gateways 33-37 are used to provide access to their associated database servers 38e-38i only to authorized individuals, groups or agencies. Shown are a secret service/customs database server 30 with a gateway 38a, an IRS database server 31 with a gateway 38b, a Social Security database server 39 with a gateway 38c, a CIA database server 32 with a gateway 38d, an IBIS database server 33 with a gateway 38e, a State Department database server 34 with a gateway 38f, an FBI database server 35 with a gateway 38g, an Immigration and Naturalization Service (INS) database server 36 with a gateway 38h, and a DOT/FAA database server 37 with a gateway 38i.

The homeland security trust authority server 28f is permitted access to all database servers 30-39 connected to secure government network 29. As previously described, such access to government database servers is typically only for the purpose of comparing information stored in a government databases 31-39 with information from a document submitted by a person, such as a passport, or directly from the person at a document validation terminal 12 or document creation terminal 13 and returning an indication that the comparison indicates a “match” or “no match”. In this manner privacy concerns are adequately addressed while documents are validated and identities verified.

Similar databases 26 located in cooperating foreign countries may also be accessed via secure servers 28d, and foreign police databases such as Interpol database 27 may also be accessed via a secure server 28e.

As previously described, there are certain types of information, or certain conditions under which certain types of information may not be compared at a trust authority server 28 but, instead, be forwarded directly to verification system server 10 and thence to a document creation terminal 13 or to a document validation terminal 12 for the sole purpose of verifying the document applicant, document or its presenter. No direct connections between server 10 and such a database are shown.

In FIG. 3 is a block diagram showing the steps involved to basically validate any type of document and the identity of any person. With reference to a validation terminal 12, when a passport is submitted to travel the document is first read to identify that it is a passport, the country that issued it, its series and other information regarding the passport. Using this information, details about the document type, including security features utilized for the document, are retrieved at block 54 and a first level of document validation is commenced to determine if the passport is valid, is a counterfeit or has been altered. Such validation testing is known in the art and such testing is described in detail in U.S. patent application Ser. No. 09/994,399 filed Nov. 26, 2001 and entitled “Validation and Verification Apparatus and Method”.

FIG. 4 shows a block diagram of the program operations performed in a trust authority server to retrieve information from databases associated with the trust authority servers to verify source information forwarded from a verification system server 10. At the start of the program, at block 48 the trust authority server program is awaiting receipt of a verification request and source information from a verification system server 10 to verify the source information. When such a verification request is received, the program progresses to block 49.

At block 49 the selected trust authority server program retrieves the appropriate information from its associated database. At block 50 the program compares the information retrieved from the database with the source information. At block 51 the program determines if the information comparison has resulted in a “match” or “no match” decision. At block 52 the result of the information comparison made at block 51 is returned to verification system server 10 where the results of the information comparison are returned to the terminal 12 that originally requested the source information verification. The program then returns to block 48 to await another source information verification request from a verification system server 10.

Using the fingerprint comparison example given above, the homeland security trust authority server 28f must issue a request over secured government network 29 to gateway 38g for the fingerprints of the document presenter. Server 28f compares the retrieved fingerprint with the source fingerprint and returns the result of this comparison to verification system server 10 that forwards the results to the terminal 12 or 13 that originally generated the fingerprint source information verification request.

In FIG. 5 is shown a program block diagram of the steps performed in real time for multi-level, rigorous checking of document validity, and identity checking of the individuals to whom they are issued, and presenters of documents in accordance with the teaching of the present invention.

As previously described a document may be presented to access more than one privilege. For example a passport may be used to travel by aircraft and may be used to purchase alcoholic beverages. In accordance with the teaching of the present invention the additional checking steps performed for an identity document such as a passport presented for air travel to another country are more rigorous than the checking steps performed when the passport is presented to travel on a bus, and even fewer checking steps are performed if the same document is presented to purchase alcoholic beverages in a liquor store. In summary, the checking protocol for each type of document varies depending where and why the document is presented and for what privilege.

Whether or not the prior art checking of document validity and/or identity verification described above indicate any problems with documents or identity, with the present invention further decisions are made as to whether or not additional, more rigorous levels of document validation and identity verification checking are required for certain types of documents or individuals.

For example, if a document being checked and validated is read and is determined to be a passport from a specific country, the first step is to determine what type of additional validation checking should be performed for passports from that country. It is known that specific countries very carefully perform identity and background checks before issuing passports or other documents, and there are no problems with corrupt government officials wrongfully issuing otherwise valid passports or other documents to criminals, terrorists or others. Accordingly, it is not normally necessary to perform many additional checks, or rigorous validation checks on documents and identity checks on the persons carrying and submitting such documents from the specific countries. Any additional document checking and identity verification steps may be reduced and the overall checking and verification process is speeded up. This is particularly important at busy ports of entry to countries such as major international airports.

There are some countries that do not carefully perform identity and background checks before issuing passports and other documents, and other countries where corrupt officials wrongfully issue passports and other documents or sell them blank to terrorist or criminal organizations. Accordingly, otherwise valid passports and other documents end up in the hands of criminals, terrorists and others with phony names and information thereon. Thus, it is necessary to perform additional, more rigorous validation checks using various databases to determine if a passport or other document has been validly issued, has been validly issued to the right person, and to determine if a person bearing and presenting a passport or other document is wanted, is on a watch list, is authorized to access some location, or is authorized to take part in some activity such as travel. Finally, a record of use of the passports or other document can be made.

As previously described the basic document validation and identity verification is first performed. At decision block 55 it is decided when the basic checking functions are completed. While the basic checking functions are in progress the program continuously cycles back via the NO output of block 55 to the input of block 55. When the basic checking functions are completed the program exits block 55 at YES and progresses to block 56 where it is determined what a first set of additional, more rigorous tests should be performed. At block 57 the additional tests are performed.

In the following paragraphs only simple examples are given of the more rigorous document and identity testing/checking that may be performed. In actuality there are many more types of checking that may be performed, and many more permutations of the checking that may be performed.

For one example, upon reading a passport submitted for travel and entry into a country it may be determined that the passport appears to be valid but is from a country that does not perform rigorous identity and background checks before issuing passports, and or where corrupt officials wrongfully issue passports and other documents or sell them blank to terrorist or criminal organizations. A first, further check may be to use the system shown in and described with reference to FIGS. 1 and 2 to first access ones of a number of databases 32-37 using U.S. government servers as part of checking a passport number and the biometrics obtained from the submitted passport and/or the person submitting the passport to determine what is stored in the databases about the person and the passport. If the person has previously entered the U.S. as may be indicated by stamps on the submitted passport, or personally averred to by the person, there will be a record in one(s) of the databases, possibly such as 34 or 36. If there is no such record the person is suspect and further checking is required. The passport may have been reported stolen and this will be determined. The bearer of the passport may be wanted or on a watch list.

If the checks at databases 32-37 described in the previous paragraph comprise the first set of checks, it is determined by the periodic decisions made at decision block 58 that the first set of check(s) are completed and the program exits block 58 at YES. Otherwise the program exits block 58 at NO and continues to watch to determine when the first set of checks are completed.

When the decision at block 58 is YES the program progresses to block 59 where the first set of checking results are analyzed. The program then progresses to decision block 60 where it is decided if further document validity and/or identification verification checks are to be performed. If the decision is YES the program cycles back to block 56 where the second set of such checks to be performed are determined.

At block 56 it may be determined that the second level of more rigorous checks is only to access the Interpol server 27. The program again progresses through the steps performed in blocks 57-60 as part of this second level of checking. After the results of the Interpol server check are analyzed at block 59 it may be determined that more checking is so the program again exits block 60 and returns to block 56.

At block 56 the third time the program may determine that server 26 of one or more cooperating countries is to be accessed, which may include an appropriate server 26 at the country whose name is on the passport, to determine if that country actually issued the passport being checked and to verify that it was issued to the person carrying the passport.

When the specified multi-level, more rigorous sets of document validity and identity verification checks have been performed the program exits block 60 at NO to block 61 which reports the testing results at the document verifier terminal 12 at which the document being checked has been submitted. In an alternative embodiment of the invention after each set of tests are performed the test results can be reported at the above mentioned terminal 12 and the operator of the terminal can manually override the automatic testing sequences and/or manually select other tests to be performed.

When it is first determined that a passport is issued by a country that performs very thorough background and identification checks before issuing a passport, the decision process described above for FIG. 5 results in much less rigorous multi-level checking of documents and individuals. Thus, upon a determination that a submitted passport is a U.S. passport for which rigorous checking is done during the issuance of the passport, fewer document validation checks are performed than if the submitted passport is from a terrorist supporting country which has been known to issue their passports to terrorists. For example, using the previously described network of databases shown in FIGS. 1 and 2, only state department database server 34 and the INS database server 36 may be checked and there are no further checking steps performed.

During the more rigorous document validation and identity verification testing, other than the few tests described above a variety of other tests may be performed. For one example, if the submitted document being checked is a U.S. passport, a validation terminal 12 may access the U.S. State Department passport data base 34 to determine if the passport was validly issued to the person named on the passport being checked. This access is accomplished via bus 11, server 10, and homeland security trust authority server 28f into a secure government network 29 where a state department passport database 34 may be accessed via its gateway 38f. To address privacy issues the homeland security trust authority server 28f does not permit government databases to be directly accessed. Rather, as described in U.S. patent application Ser. No. 10/022,634 filed Dec. 17, 2001 and entitled “Document and Bearer Verification System, servers 10 and 28f cooperate with the government databases to only return a Yes or No response to the validation terminal 12 which is checking that the passport was issued to the named person.

Further, if problems arise during an earlier document and identity checking step, the process may be altered on the fly and biometric data embedded on a document, such as a fingerprint or iris print, may be actually compared to the fingerprint or iris print of the bearer/presenter of the document at terminal 12 or a remote government database. A validation terminal 12 may have a fingerprint reader 14, an iris scanner 15 and a camera 16 connected thereto for directly obtaining biometric information. Such biometric information obtained directly from the bearer/presenter may also be forwarded via bus 11, and servers 10 and 28 to the FBI fingerprint database for automatic comparison and identity of the person. In addition, at validation terminal 12 a picture may be taken of the bearer/presenter of a document using camera 16. That picture may be forwarded to a government database as previously described to be compared with an archived photograph of the person. Again either a match or no match response may be returned. If there is a matching problem the retrieved, archived photograph may be returned to validation terminal 12 to be displayed and manually compared to the person by the operator of the terminal. Depending upon the specific application of a validation terminal 12 some or all of the attachments 14-16 may not be provided or utilized.

The aforementioned government, state and private databases are presently created and maintained by the issuing authority for each document type and by other organizations that have the control authority or operational charter to do so as a part of their operational model. New trust authorities authorized to access such databases, as described above, will be used to access the databases using standardized privacy protected ID data routing, and a query/response system focused on risk assessment. That is, the trust authority server 28 for federal government databases will compare information, such as a birth date retrieved by a document validation terminal 12 from a submitted document against the birth date stored in its associated database and return a response of “match” or “no match” to the remote terminal 12 that initiated the inquiry for a birth date verification. Similarly, a birth date submitted by an applicant at a document creation terminal 13 will similarly be checked against such databases.

For birth records the database(s) connected to state agency trust authority server 28 a&bwill be accessed. The database(s) of each state will be accessed via server 28 a&b. For another example, a trust authority server 28 will compare other information, such as the submitted maiden name of a document applicant's mother, to such information stored in a state birth record database and return a response of “match” or “no match” via the intermediate servers to the remote document creation terminal 13 that initiated the inquiry. Alternatively, in cases where databases may be accessed, but there is no trust authority server associated therewith, verification system server 10 may act as the trust authority, perform verification checks and return the same information comparison results to requesting ones of terminals 12 and 13. In this manner privacy issues are adequately addressed since there is usually no access to database contents, and actual information in the database(s) is not disclosed at any terminal 12 or 13. In some circumstances information retrieved from a database, such as a photo, will not be matched at the associated trust authority server but may instead a stored photo be returned to the terminal 12 or 13 from which the request was initiated, and an operator who made the request for the photo will perform a manual comparison of the photo retrieved from the database with the document presenter.

Criteria other than listed above may also be specified regarding documents or their bearers that will cause closer inspection of documents or their bearers. For example, if an unidentified murderer or terrorist is known to be in a given age range, sex, height and weight, all persons submitting documents with such biometric characteristics thereon may be flagged for closer scrutiny to determine if they are the wanted individual. Additional steps of more rigorous document validity and identity verification checking are then performed that are not performed on documents from the same country that issued the document.

While the above description is for more rigorous checking of a document, such as a passport and a person submitting the document, for travel purposes, the invention may also be used when checking the verifying the identification of persons and supporting documents they submit when applying to obtain new, original or replacement documents. It is advantageous that the multi-step testing in accordance with the teaching of the invention is even more rigorous when verifying identity and checking the validity of submitted, supporting documents, such as birth certificates, than when issued documents are presented to submitted to access some location, or take part in some activity including travel.

Document creation terminals 13 are used to generate originals and copies of official documents. At terminals 13 document validity and identity verification is performed, as previously described, to determine if a person that is requesting an original or a copy of a document is entitled to it. This will often require checking the validity of documents submitted by a person requesting a document as part of proving that they are who they claim to be. The steps and levels of checking documents and identity are the same as described above, except that they may be even more rigorous as described in the previous paragraph.

In the U.S. there are many federal, state, municipal and private databases. A U.S. citizen will normally have historical records in these many databases showing their existence over the years of their life. If there are no such records in existence in the databases a person is obviously suspect and further checking is necessary. In addition, the information from the many databases can be compared with information obtained directly from a person to resolve incongruities and as part of double checking their identity. In this manner it makes it very difficult, if not impossible, for someone to wrongfully obtain, or to use a wrongfully obtained, altered or counterfeit document.

For example, a U.S. citizen may apply to have a U.S. passport issued to them in order to travel abroad. They will fill out appropriate application forms and provide supporting documentary proof such as a birth certificate and driver's license. As previously described birth certificates and driver's licenses are too easily falsely obtained. Using the teaching of the subject invention a first level set of tests to be performed per FIG. 5 would be to use the system described with reference to FIGS. 1 and 2 to access the appropriate state driver's license server 24 to check the drivers license, and to check the same or different state server 24 to check the birth certificate. This check may also include downloading a photograph from the driver's license server to visually compare with the passport applicant.

During a second level of tests the Social Security server 39 may be accessed to check the applicant's Social Security number and to check the FBI server 35 to determine if the passport applicant is wanted or is on a watch list.

During a third level of tests the passport applicant's fingerprint may be taken and submitted to the FBI fingerprint server (and even an iris print server in the future) to determine if the person is who they claim to be, in the event that their fingerprints were ever taken and stored in the FBI fingerprint database accessed via server 35. During this same level of tests, or during a fourth level of tests, personal information submitted such as schools attended may be compared against a state or local database server in which are stored educational records. Such personal information may preferably be requested at the time a passport application is being submitted in order to minimize any efforts to develop such information ahead of time since it will not be known what information will be requested.

If at any time during this rigorous testing there is no match between submitted information and information stored in the various database servers shown in FIG. 2 there is obviously a problem and it is reported at program block 61 and FIG. 5 to the operator at a document creation terminal 13 where the passport application is being checked. A decision may be made to detain the person.

Expanding on the above description of checking documents and individuals more rigorously, there may be an overlap between the initial document and identity verification checks of the prior art and the more rigorous expanded testing in accordance with the teaching of the invention.

While what has been described hereinabove is the preferred embodiment of the invention it will be obvious to those skilled in the art that numerous changes may be made without departing from the spirit and scope of the invention.

What is claimed is:

1. A method for managing generally automated, multilevel verification processing of an already identified document type and of a person presenting the document, the multilevel processing to be performed being done using data in ones of a plurality of databases and which databases are used is dependent upon many factors such as, but not limited to, the purpose for which the document is presented, the type of document presented, the source of the document, the risk circumstances under which the document is being processed, and the specific location at which the document is being presented, the method comprising the steps of:
(a) performing verification processing on the identified document and of the identity of the person presenting the document using ones of the databases selected based on the factors;
(b) determining if additional verification processing is required of the document and the identity of the person presenting the document based upon the results of the processing performed in step (a), such additional verification processing to be performed using others of the databases;
(c) ceasing verification processing of the document and of the identity of the person presenting the document if it is determined in step (b) that no additional verification processing is required;
(d) performing additional verification processing on the document and the identity of the person presenting the document if it is determined in step (b) that such additional verification processing is required using the others of the databases;
(e) determining if additional verification processing is required of the document and the identity of the person presenting the document based upon the results of the verification processing performed in step (d), such additional verification processing to be performed using yet others of the databases;
(f) ceasing verification processing of the document and of the identity of the person presenting the document if it is determined in step (e) that no additional verification processing is required;
(g) repeating steps (a) through (f) using yet others of the databases if it is determined in step (e) that additional verification processing is required; and
(h) providing an indication that either there are or there are not concerns about the document and the person presenting the document based on the results of the multilevel verification processing.

2. The method for managing generally automated, multilevel verification processing of an already identified document and of a person presenting the document in accordance with claim 1 wherein the step (h) of providing an indication that there are or there are not concerns about the document and the person presenting the document are provided after each performance of verification processing performance steps (a) and (d).

3. The method for managing generally automated, multilevel processing of an already identified document and of a person presenting the document in accordance with claim 2 wherein additional verification processing determination steps (b) and (e) may be performed manually or automatically.

4. The method for managing generally automated, multilevel verification processing of an already identified document and of a person presenting the document in accordance with claim 3 wherein the databases selected in steps (b), (e) and (g) may be manually selected.

5. The method for managing generally automated, multilevel verification processing of an already identified document and of a person presenting the document in accordance with claim 4 wherein the databases chosen for the verification processing performance steps (a) and (d) are dependent upon a level of trust placed in the authority that issued the document undergoing verification processing.

6. The method for managing generally automated, multilevel verification processing of an already identified document and of a person presenting the document in accordance with claim 5 wherein the indication provided in step (h) may include an indication to detain the person presenting the document.

7. The method for managing generally automated, multilevel verification processing of an already identified document and of a person presenting the document in accordance with claim 6 wherein during the performance of steps (a) through (d) data is obtained from the ones or the others of the data bases and further comprising the step (i) of determining if any of the data obtained from the ones or the others of the data bases should be retained.

8. The method for managing generally automated, multilevel verification processing of an already identified document and of a person presenting the document in accordance with claim 1 wherein additional processing verification determination steps (b) and (e) may be performed manually or automatically.

9. The method for performing generally automated, multilevel verification processing of an already identified document and of a person presenting the document in accordance with claim 8 wherein the databases selected in steps (b), (e) and (g) may be manually selected.

10. The method for managing generally automated, multilevel verification processing of an already identified document and of a person presenting the document in accordance with claim 9 wherein the databases chosen for the processing performance steps (a) and (d) are dependent upon a level of trust placed in the authority that issued the document undergoing verification processing.

11. The method for managing generally automated, multilevel verification processing of an already identified document and of a person presenting the document in accordance with claim 1 wherein the databases chosen for the processing performance steps (a) and (d) are dependent upon a level of trust placed in the authority that issued the document undergoing processing.

12. The method for managing generally automated, multilevel verification processing of an already identified document and of a person presenting the document in accordance with claim 11 wherein the indication provided in step (h) may include an indication to detain the person presenting the document.

13. The method for managing generally automated, multilevel verification processing of an already identified document and of a person presenting the document in accordance with claim 12 wherein during the performance of steps (a) through (d) data is obtained from the ones or the others of the data bases and further comprising the step (i) of determining if any of the data obtained from the ones or the others of the data bases should be retained.

14. A method for managing generally automated, multilevel verification processing to verify the identity of a person seeking issuance of a document, such as but not limited to, a passport, where the person submits identity documents such as birth certificates, biographical information about the person's life, and their biometrics such as, but not limited to, fingerprints, iris scans and DNA samples, the multilevel verification processing to be performed being done using data in ones of a plurality of databases that may or should contain information about the person including, including but not limited to, their biographical, biometric information and supporting documents, and which databases are used is dependent upon many factors such as, but not limited to, the type of document sought to be issued, the method comprising the steps of:
(a) performing verification processing of a portion of the supporting documents, biographical information and the biometrics of the person presenting same using ones of the databases selected for the processing;
(b) determining if additional verification processing is required of other portions of the supporting documents, biographical information and the biometrics of the person same based upon the results of the verification processing performed in step (a), such additional verification processing to be performed using others of the databases;
(c) ceasing verification processing of the supporting documents, biographical information and the biometrics of the person if it is determined in step (b) that no additional verification processing is required;
(d) performing additional verification processing on the supporting documents, biographical information and the biometrics of the person if it is determined in step (b) that such additional verification processing is required using the others of the databases;
(e) determining if additional verification processing is required of the supporting documents, biographical information and the biometrics of the person based upon the results of the verification processing performed in step (d), such additional verification processing to be performed using yet others of the databases;
(f) ceasing verification processing of the supporting documents, biographical information and the biometrics of the person if it is determined in step (e) that no additional verification processing is required;
(g) repeating steps (a) through (f) using yet others of the databases if it is determined in step (e) that additional verification processing is required; and
(h) providing an indication that either there are or there are not concerns about the person based on the results of the multilevel verification processing.

15. The method for managing generally automated, multilevel verification processing to verify the identity of a person seeking issuance of a document in accordance with claim 14 wherein the step (h) of providing an indication that there are or there are not concerns about the person are provided after each performance of processing performance steps (a) and (d).

16. The method for managing generally automated, multilevel verification processing to verify the identity of a person seeking issuance of a document in accordance with claim 15 wherein additional processing determination steps (b) and (e) may be performed manually or automatically.

17. The method for managing generally automated, multilevel verification processing to verify the identity of a person seeking issuance of a document in accordance with claim 16 wherein the databases selected in steps (b), (e) and (g) maybe manually selected.

18. The method for managing generally automated, multilevel verification processing to verify the identity of a person seeking issuance of a document in accordance with claim 17 wherein the databases chosen for the processing performance steps (a) and (d) are dependent upon a level of trust placed in the authority that issued the document undergoing verification processing.

19. The method for managing generally automated, multilevel verification processing to verify the identity of a person seeking issuance of a document in accordance with claim 14 wherein additional verification processing determination steps (b) and (e) may be performed manually or automatically.

20. The method for managing generally automated, multilevel verification processing to verify the identity of a person seeking issuance of a document in accordance with claim 19 wherein the databases selected in steps (b), (e) and (g) maybe manually selected.

21. The method for managing generally automated, multilevel verification processing of an already identified document and of a person presenting the document in accordance with claim 20 wherein the databases chosen for the processing performance steps (a) and (d) are dependent upon a level of trust placed in the authority that issued the document undergoing verification processing.

22. The method for managing generally automated, multilevel verification processing of an already identified document and of a person presenting the document in accordance with claim 21 wherein the indication provided in step (h) may include an indication to detain the person presenting the document.

23. The method for managing generally automated, multilevel verification processing of an already identified document and of a person presenting the document in accordance with claim 22 wherein during the performance of steps (a) through (d) data is obtained from the ones or the others of the data bases and further comprising the step (i) of determining if any of the data obtained from the ones or the others of the data bases should be retained.

24. The method for managing generally automated, multilevel verification processing to verify the identity of a person seeking issuance of a document in accordance with claim 14 wherein the databases chosen for the processing performance steps (a) and (d) are dependent upon a level of trust placed in the authority that issued the document undergoing verification processing.

25. The method for managing generally automated, multilevel verification processing of an already identified document and of a person presenting the document in accordance with claim 24 wherein the indication provided in step (h) may include an indication to detain the person presenting the document.

26. The method for managing generally automated, multilevel-verification processing of an already identified document and of a person presenting the document in accordance with claim 25 wherein during the performance of steps (a) through (d) data is obtained from the ones or the others of the data bases and further comprising the step (i) of determining if any of the data obtained from the ones or the others of the data bases should be retained.

27. The method for managing generally automated, multilevel-verification processing of an already identified document and of a person presenting the document in accordance with claim 14 wherein the verification processing is performed without disclosing database information to anyone.

28. The method for managing generally automated, multilevel verification processing of an already identified document and of a person presenting the document in accordance with claim 1 wherein wherein the verification processing is performed without disclosing database information to anyone.
